(19) United States
(12) Patent Application Publication
(10) Pub. No.: US 2015/0056041 A1
(43) Pub. Date: Feb. 26, 2015

(54) DUAL-LAYER DRY BOLT COATING

(71) Applicant: GM Global Technology Operations LLC, Detroit, MI (US)

(72) Inventors: Christopher B. Preston, Troy, MI (US); Timothy M. Wilson, Howell, MI (US); David M. Woodard, Grosse Pointe Park, MI (US); Chun K. Kwong, Pontiac, MI (US)

(73) Assignee: GM GLOBAL TECHNOLOGY OPERATIONS LLC, Detroit, MI (US)

(21) Appl. No.: 14/157,836

(22) Filed: Jan. 17, 2014

Related U.S. Application Data
(60) Provisional application No. 61/868,753, filed on Aug. 22, 2013.

(51) Int. Cl. F16B 33/06

(52) U.S. Cl. CPC F16B 33/06
USPC 411/378; 427/385.5; 427/240

(57) ABSTRACT

A bolt includes a body and a threaded portion formed on the body. The bolt further includes a phosphate base coat, which covers at least the body and is in direct contact with the body. The bolt also includes a PTFE overcoat, which substantially covers the phosphate base coat and is separated from the body of the bolt by the phosphate base coat.

### CROSS-REFERENCE TO RELATED APPLICATIONS

This application claims the benefit of U.S. Provisional Application No. 61/868,753, filed Aug. 22, 2013, which is hereby incorporated by reference in its entirety.

### TECHNICAL FIELD

This disclosure relates to bolts and fasteners and, more particularly, to coatings for bolts and fasteners.

### BACKGROUND

Bolts and fasteners are used in some industrial or automotive applications to hold or connect two or more objects. Bolts and fasteners may be provided with a coating or coating layer.

### SUMMARY

A coated bolt is provided. The bolt includes a body and a threaded portion formed on the body. The bolt further includes a phosphate base coat and a PTFE overcoat. The phosphate base coat covers at least the body, and is directly adjacent to the portion of the body covered by base coat. The PTFE overcoat substantially covers the phosphate base coat and is separated or spaced from the body of the bolt by the phosphate base coat.

The above features and advantages, and other features and advantages, of the present invention are readily apparent from the following detailed description of some of the best modes and other embodiments for carrying out the invention, which is defined solely by the appended claims, when taken in connection with the accompanying drawings.

### BRIEF DESCRIPTION OF THE DRAWINGS

FIG. 1 is a schematic isometric view of a dry-coated bolt;

FIG. 2 is a schematic partial cross-sectional view of the dry-coated bolt, taken generally along illustrative line 2-2 of FIG. 1; and

FIG. 3 is a schematic flow chart illustrating a process or method for manufacturing dry-coated bolts, such as that shown in FIG. 1.

### DETAILED DESCRIPTION

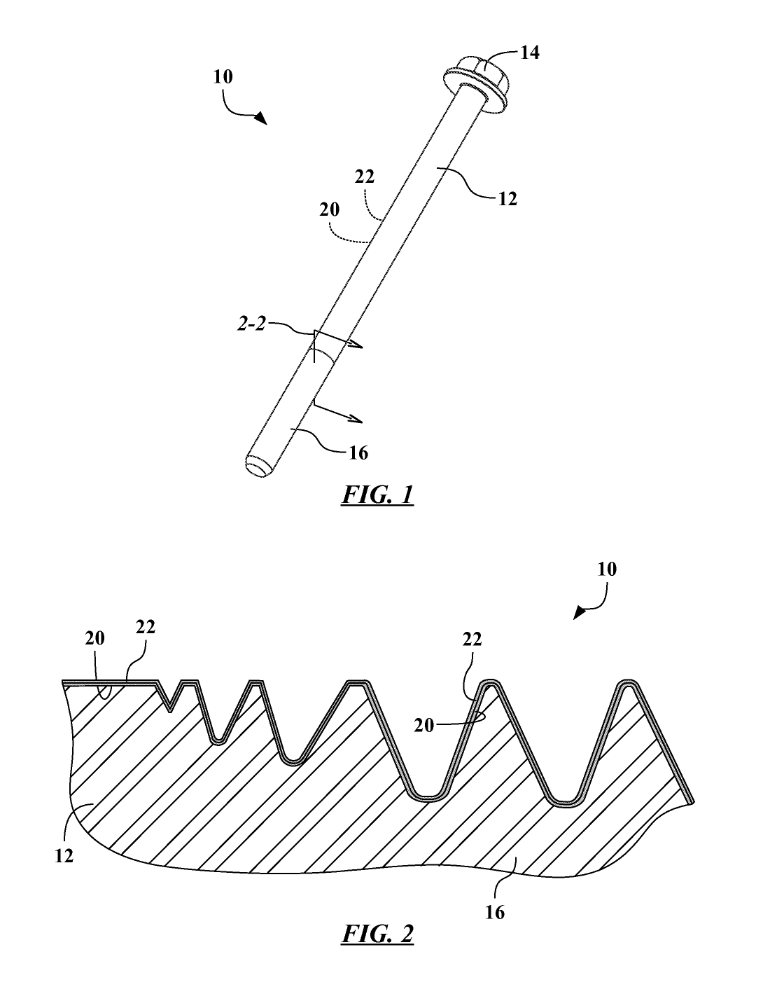

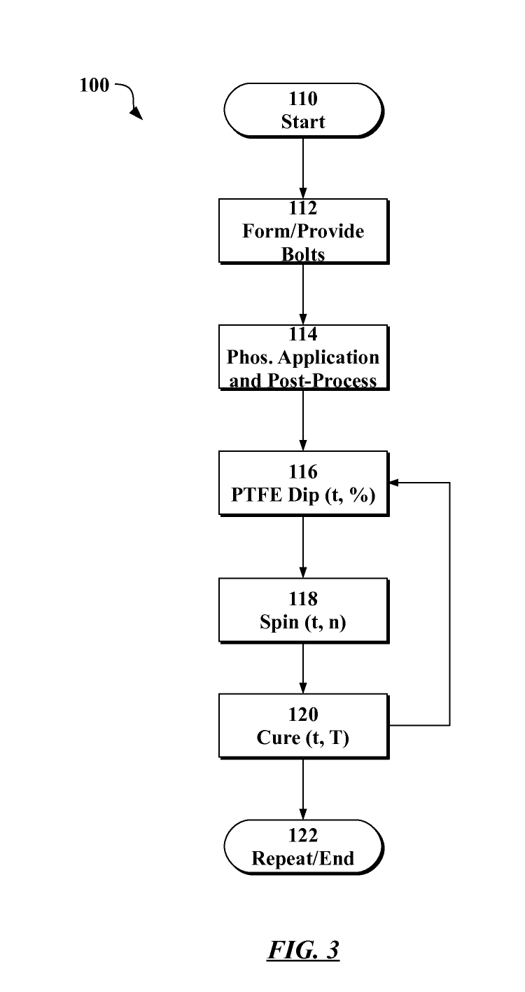

Referring to the drawings, like reference numbers correspond to like or similar components wherever possible throughout the several figures. There is shown in FIG. 1 a bolt 10. FIG. 2 shows a highly schematic cross-sectional view of a portion of the bolt 10 taken generally along a line 2-2 of FIG. 1. The schematic bolt 10 is highly illustrative and represents many different shapes, sizes, and configurations of bolts and fasteners.

Those having ordinary skill in the art will recognize that terms such as “above,” “below,” “upward,” “downward,” et cetera, are used descriptively of the figures, and do not represent limitations on the scope of the invention, as defined by the appended claims. Any numerical designations, such as “first” or “second” are illustrative only and are not intended to limit the scope of the invention in any way.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

As shown in FIG. 1, the bolt 10 includes a shaft or body 12 and a head portion 14 formed on one end of the body 12. The head portion 14 may be used for assembly of the bolt 10 and may be configured to interface with a driver (not shown). The head portion 14 is illustrative only and may have shapes and structure varying from that shown. Alternatively, the bolt 10 may be driven via an embedded slot or key, such that the head 14 is not included.

The bolt 10 also includes a threaded portion 16 formed on the body 12. Note that the threaded portion 16 is shown schematically in FIG. 1, such that individual threads are not viewable, but is partially illustrated in FIG. 2, which shows a transition region between the body 12 and the threaded portion 16.

In many cases the threaded portion 16 will be formed opposite the head portion 14. However, and because the head portion 14 may not be included, the thread portion 16 may be formed on either end of the body 12. Alternatively, the threaded portion 16 may be formed internally, such that the bolt 10 is like a nut or female receptacle.

The bolt 10 may be formed from ferrous base materials, including steel and stainless steel. Alternatively, the bolt 10 may be formed from aluminum, magnesium, zinc, alloys or combinations thereof, or other suitable materials. Furthermore, the bolt 10 may undergo manufacturing processes or treatments to improve its strength, durability, or other material properties.

The bolt 10, or a plurality of bolts 10, may be used with a bolt feeder (not shown). The bolt feeder is configured to take the plurality of bolts 10 from unorganized and unaligned positions, such as those existing in a hopper, to uniformly aligned positions ready for use in an assembly or manufacturing process. Generally, the bolts 10 are used to rigidly or semi-rigidly attach one or more components together, possible with the use of a corresponding nut and one or more washers.

To control the installation of the bolt 10, the bolt 10 may need a specific coefficient of friction (CoF). One method for controlling the coefficient of friction of the bolt 10 is to apply a coating such as oil or wax, which may be referred to as a wet coating.

The wet coating is not permanently (or semi-permanently) adhered or affixed to the bolts 10 and may, therefore, by wiped or rubbed off by the bolt feeder or other assembly or transportation equipment. Additionally, the wet coating may trap debris, such as dust or metallic flakes on the surface of the bolts 10. Residue from the wet coating, including debris trapped by the wet coating, may collect on the bolt feeder or other equipment.

The bolt 10 includes a phosphate base coat 20 that covers at least the body 12, but likely covers the entire bolt 10. The phosphate base coat 20 is directly adjacent to the body 12, is applied directly to the base material forming the bolt 10, and is completely adhered to the base material of the bolt 10. The application of the phosphate coating 20 is by a chemical reaction between the of the surface of the bolt 10 and a solution of phosphoric acid and metallic phosphate salts, such as manganese, zinc, iron, or others. The chemical reaction generally occurs by immersion of the bolt 10 into the chemical solution. Additional or modified processes—including cleaning, surface activation, or rinsing—may be used to apply the phosphate base coat 20 to the bolt 10.

After application of the phosphate base coat 20, the bolt 10 also receives a PTFE overcoat 22, which substantially covers the phosphate base coat 20. Therefore, the PTFE overcoat 22 is separated, spaced, or offset from the body 12 by the phosphate base coat 20, at least where the phosphate base coat 20 and the PTFE overcoat 22 overlap. In many configurations of the bolt 10, both the phosphate base coat 20 and the PTFE overcoat 22 will cover the entire bolt 10.

The phosphate base coat 20 and the PTFE overcoat 22 are best illustrated in FIG. 2. However, note that FIG. 2 is schematic and is illustrative only. Both the phosphate base coat 20 and the PTFE overcoat 22 may be illustrated with greater thickness than most applications. The actual thicknesses of the phosphate base coat 20 and the PTFE overcoat 22 may not be visible on the scale shown. Additionally, the combined thickness of the phosphate base coat 20 and the PTFE overcoat 22 will likely be limited by tolerances for the body 12 and the threaded portion 16, so that the bolt 10 can serve its functional purpose after the coatings have been applied.

The PTFE overcoat 22 is the outer-layer of the bolt 10 and comes into contact with, for example, bolt feeders through which the bolt 10 passes. The PTFE overcoat 22 also comes into contact with components to which the bolt 10 is assembled. The PTFE topcoat 22 is a major contributor to the coefficient of friction of the bolt 10, and therefore strongly affects the installation of the bolt 10. The PTFE overcoat 22 acts to reduce the coefficient of friction of the bolt 10, which may benefit the assembly processes.

The PTFE overcoat 22 is a water-based inorganic solution including, at least, polytetrafluoroethylene (PTFE). The PTFE may be in particulate form and the water-PTFE solution may also include a polymeric binder and other elements configured to promote the coating process.

The phosphate base coat 20 has a generally-crystalline structure that provides a base for the PTFE overcoat 22 to which the PTFE overcoat 22 clings while wet (in water-PTFE solution) and adheres after curing. Additional materials—other than water and PTFE—may be incorporated to improve the final performance characteristics or to facilitate the coating and adhesion process of a water-PTFE solution that will be cured into the final PTFE overcoat 22. Pigment may also be added to the water-PTFE in order to identify bolts 10 having the PTFE overcoat 22 applied, as opposed to those waiting for application or similar bolts having different coatings.

After completing the coating processes—as described herein—the bolt 10 has a dry finish or dry coating, as opposed to a wet coating, such that the bolt 10 is characterized by the absence of oil or pliant waxes. As used herein, dry coatings are those that are dry to touch. One method for determining whether the bolt 10 is dry to touch is to hold the coated, final, bolt 10 with white tissue paper while applying light hand pressure (for example, approximately ten Newtons of force) for a prescribed time period (for example, approximately five seconds). If there is no visible staining or discoloration to the tissue paper, then the coating is dry.

The finished bolt 10 may have a coefficient of friction between 0.10-0.16. This exemplary coefficient of friction, or other values, may be achieved by varying the concentration of PTFE in the water-PTFE solution used to coat the bolt 10 before curing. Furthermore, the curing process may affect the coefficient of friction of the bolt 10.

Referring now to FIG. 3, and with continued reference to FIGS. 1-2, there is shown a method 100 for coating a plurality of bolts, such as the bolt 10 shown in FIG. 1. The method 100 may be completely or partially automated and controlled by a control system (not shown) or may be executed manually.

FIG. 3 shows only a high-level diagram of the method 100. The exact order of the steps of the algorithm or method 100 shown may not be required. Steps may be reordered, steps may be omitted, and additional steps may be included. Steps shown in dashed or phantom lines may be optional. However, depending upon the specific configuration, any steps may be considered optional or may be implemented only selectively. Furthermore, the method 100 may be a portion or sub-routine of another algorithm or method.

For illustrative purposes, the method 100 is described with reference to elements and components shown and described in relation to FIG. 1 and may be executed on one or more bolts 10. However, other components may have the method 100 applied in order to dry coat other parts.

Step 110: Start/Initiate.

The method 100 may begin at a start or initialization step, during which time the method 100 is made active and required components or equipment are made active.

Step 112: Form or Provide Bolts.

The method 100 includes forming or providing, such as from a supplier, the plurality of bolts 10. The method 100 is primarily described relative to multiple components because economies of scale (production or cost efficiencies) would likely result from coating numerous bolts 10. However, the method 100 could be applied to a single component, particularly if the bolt 10 is a large, complex, or produced from prototype purposes.

Step 114: Phosphate Base Coat Application and Post-Processing.

The method 100 for coating the plurality of bolts 10 includes applying the phosphate base coat 20 to the plurality of bolts 10. Furthermore, the method 100 may include any necessary post-processing of the bolts 10 after receiving the phosphate base coat 20, particularly post-processing necessary to prepare the bolts 10 for subsequent coating.

Step 116: Dip in Water-PTFE Solution.

The method 100 includes applying the PTFE overcoat 22 after applying the phosphate base coat 20. Applying the PTFE overcoat 22 may involve dipping the plurality of bolts 10 in a water-PTFE solution for a dip time period. Therefore, some of the control parameters for the applying the PTFE overcoat 22 include the concentration (which may be expressed as a percentage) of PTFE in the water-PTFE solution and the time (t) or period during which the bolts 10 are within the water-PTFE solution. These control parameters may vary the thickness of the PTFE overcoat 22, the coefficient of friction of the PTFE overcoat 22, or both.

In some configurations of the method 100, the dip time period may actually represent a process of spraying the water-PTFE solution onto the bolts 10, such as while being carried on a conveyor system. In such a configuration, the parameters of the dip period may also include a flow rate or a flow rate per bolt 10.

Step 118: Spin.

The method 100 includes removing the plurality of bolts 10 from the water-PTFE solution following the dip time period. The plurality of bolts 10 may then undergo a spinning process for a spin time period and a rotation rate. Spinning the bolts 10 may remove any excess water-PTFE solution or droplets thereof. Therefore, some of the control parameters for spinning the bolts 10 include the spin time (t) and spin rate (n), which may be expressed in RPM. Some configurations of the method 100 may supplement or substitute the spin process with shaking or vibrating. Additionally, the spinning process may include two spin cycles.

Step 120: Curing the PTFE Overcoat.

Following the spin time period, the method 100 cures the bolts 10, which are wet-coated with the water-PTFE solution. Curing the plurality of bolts 10 may occur in an oven for a cure time period at a bake temperature. Curing the water-PTFE solution creates the final, dry PTFE overcoat 22. Therefore, some of the control parameters for curing the PTFE overcoat 22 on the bolts 10 include the bake time (t) in the oven and the bake temperature (T) of the oven. The oven curing process may activate a thermosetting polymer acting as the binder for the PTFE overcoat 22, or the oven may facilitate drying of the water-PTFE solution by driving the solvent out of the solution.

Some configurations of the method 100 may supplement or substitute the oven-curing process with light-based curing, such as ultraviolet light. In configurations with a light-curable PTFE overcoat 22, the water-PTFE solution may include a binder that is curable in response to any spectrum of radiation including, for example and without limitation: ultraviolet light, visible light, or microwave.

Depending on the thickness of the PTFE overcoat 22, the method 100 may repeat the PTFE coating processes in steps 116, 118, and 120. Additional cycles may increase the thickness of the PTFE overcoat 22, improve the quality and consistency of the PTFE overcoat 22, or both.

Step 122: End/Repeat.

The method 100 ends after the PTFE overcoat 22 is cured or sufficiently cured for transportation (if the curing process will complete during transportation). The method 100 may then be repeated in similar fashion on another plurality of bolts 10.

The detailed description and the drawings or figures are supportive and descriptive of the invention, but the scope of the invention is defined solely by the claims. While some of the best modes and other embodiments for carrying out the claimed invention have been described in detail, various alternative designs, configurations, and embodiments exist for practicing the invention defined in the appended claims.

1. A bolt, comprising:
a body;
a threaded portion formed on the body;
a phosphate base coat covering at least the body, wherein the phosphate base coat is in direct contact with the body; and
a PTFE overcoat, wherein the PTFE overcoat covers substantially all of the phosphate base coat and is separated from the body by the phosphate base coat.

2. The bolt of claim 1, wherein the PTFE overcoat and the phosphate base coat are dry coatings, such that the bolt is characterized by the absence of an oil and the absence of a wax.

3. The bolt of claim 2, wherein the PTFE overcoat has a first coefficient of friction, which is substantially between 0.10 and 0.16.

4. The bolt of claim 3, wherein the PTFE overcoat has a first concentration of PTFE.

5. The bolt of claim 1,
wherein the phosphate base coat covers substantially the entire body; and
wherein the PTFE overcoat covers substantially the entire phosphate base coat and substantially the entire body.

6. The bolt of claim 5, wherein the PTFE overcoat and the phosphate base coat are dry coatings, such that the bolt is characterized by the absence of an oil and the absence of a wax.

7. The bolt of claim 6, wherein the PTFE overcoat has a first coefficient of friction, which is substantially between 0.10 and 0.16.

8. A method of coating a plurality of bolts, the method comprising:
applying a phosphate base coat to the plurality of bolts;
after applying the phosphate base coat, applying a PTFE overcoat, including:
dipping the plurality of bolts in a water-PTFE solution for a dip time period;
following the dip time period, removing the plurality of bolts from the water-PTFE solution; and
following the dip time period, curing the plurality of bolts for a cure time period.

9. The method of claim 8, further comprising:
following the dip time period and prior to the cure time period, spinning the plurality of bolts for a spin time period and a rotation rate.

10. The method of claim 9, wherein curing the plurality of bolts includes heating the plurality of bolts in an oven for the cure time period at a bake temperature.

11. The method of claim 10, wherein applying the phosphate base coat and the PTFE overcoat is characterized by the absence of oil and wax, such that the plurality of bolts have a dry coating after the cure time period.
